(19) United States
(12) Patent Application Publication
(10) Pub. No.: US 2022/0358557 A1
(43) Pub. Date: Nov. 10, 2022

(54) SYSTEM AND METHOD FOR IDENTIFYING A TARGET ORDER ITEM

(71) Applicant: Flipkart Internet Private Limited, Bengaluru (IN)

(72) Inventors: ABINAYA K, Tiruchengode (IN); Shourya ROY, Bangalore (IN); Harish BABU, Bangalore (IN); Bhavana JAYANTH, Bangalore (IN); Krishang GARODIA, Thane (IN); Utkarsh SRIVASTAVA, Balagere (IN)

(73) Assignee: Flipkart Internet Private Limited, Bengaluru (IN)

(21) Appl. No.: 17/737,828

(22) Filed: May 5, 2022

(30) Foreign Application Priority Data
May 6, 2021 (IN) 202141020714

(51) Int. Cl. G06Q 30/06; G06Q 30/02

(52) U.S. Cl. CPC G06Q 30/0629; G06Q 30/0282

(57) ABSTRACT

The present disclosure provides a method [200] and system [100] for identifying a target order item. The method encompasses identifying, by an identification unit [102], one or more active order items associated with one or more users and one or more features of the one or more active order items. Further the method encompasses determining, by a processing unit [104], a ranking score of the one or more active order items based on the feature(s) of the one or more active order items. The method then leads to comparing, by the processing unit [104], the ranking score of the active order item(s) with a threshold ranking score. Further, the method encompasses identifying, by the identification unit [102], the target order item based at least on a successful comparison of a ranking score of a first active order item from the active order item(s) with the threshold ranking score.

### TECHNICAL FIELD

The present invention generally relates to the field of Ecommerce platforms and more particularly, to a system and method for identifying a target order item based on at least one of a prediction of the target order item based on one or more associated features of one or more active order items and a searching of the target order item from the one or more active order items.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With an advancement in the field of digital technologies, the ecommerce platforms are also enhanced to a great extent. Now a days, millions of users are associated with the ecommerce platforms. The association of such millions of users leads to high volumes of service and support requests. The customer service support of the ecommerce platforms receives millions of queries related to products, fulfilment, returns and other such services. Therefore, customer service support in the ecommerce platforms performs a crucial role.

Providing efficient and effective customer support services to the millions of users is a challenging job for most of the ecommerce platforms. Also, in customer service, voice continues to be the medium of choice of the users/customers over other mediums such as chat and email. Most of the users do not go to the self-serve options and directly reach out to the customer care agents on the toll free number. Over the past few years, various user research has shown that voice is often useful in overcoming inability to type the right spelling especially in non-metro customers. Given this strong user preference for voice, assisting customers through voice becomes critical. The customer service support of the ecommerce platforms receives millions of calls per year and handling all such calls by human agents would amount to a large servicing expense. Additionally, during and after the big events such as an annual sale event, the scale of customers' calls spikes up many folds for a few days to weeks which makes it difficult to manage even from the perspective of resourcing agents.

To address the challenges related to customer service support, various solutions are developed time to time. For instance, various interactive voice response (IVR) systems and/or bots (such as voice bots) are developed to handle user queries by answering the user's questions and by resolving their issues. However these know solutions have many limitations and are not efficient. The currently known IVR systems are complex and fails to provide efficient resolutions for the customers' queries. Typical call flow of the known voice bot based solutions start with customer identification, greeting, order confirmation followed by issue identification and finally issue resolution or transfer of call to human agent if needed. These known voice bot based solutions are ineffective in identification of an order item for which a user is initiating a query indication towards a customer support platform. Generally, a huge percentage of the queries are received from the users with multiple active orders and the known voice bot based solutions fails to efficiently identify a specific order from such multiple active orders based on users' requirements. Therefore, such currently known bot based solutions failed to resolve the user's queries in events where the users have multiple active orders. To make the bots available to customers with multiple active order items, it's crucial to identify the item about which the customer is calling for. There is no existing bot based solution to efficiently identify the item about which the customer is calling for.

Furthermore, some of the currently known solutions encompasses identification of entities e.g. products using named entity recognition (NER). The identified entities can then be used to identify order items. This needs a huge amount of reliable annotated data. Also, NER on automatic speech resolution (ASR) transcripts remains a challenge due to high degree of recognition and lexical noise (e.g. missing capitalization).

Therefore, to efficiently and effectively handle the high volumes of service and support requests, there is need in the art to provide a solution to identify an ordered item from one or more active order items.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a system and method for identifying a target order item from one or more active order items associated with one or more users. Another object of the present invention is to identify the target order item based on one or more query indication from the one or more user, wherein in an implementation the one or more query indication may be one or more incoming calls from the one or more users. Another object of the present invention is to provide a solution which is completely unsupervised and works on lexical form of utterances primarily thereby having no dependency on NER, to search the target product. Also, an object of the present invention is to provide a solution which is uses various features related to the ordered item(s) and is not dependent on what customer is speaking on the line, to search the target product. Another object of the present invention is to provide a solution that can handle an impact of ASR noise while searching the target product. Another object of the present invention is to provide a solution that can handle product entity malformations arising from transcription noise. Yet another object of the present invention is to provide a solution that is not dependent on the number of active order items and hence scalable to any number of active order items.

In order to achieve the aforementioned objectives, the present invention provides a method and system for identifying a target order item from one or more active order items.

An aspect of the present invention relates to a method for identifying a target order item. The method encompasses identifying, by an identification unit, one or more active order items associated with one or more users. The method thereafter comprises identifying, by the identification unit, one or more features of the one or more active order items. Further the method encompasses determining, by a processing unit, a ranking score of the one or more active order items based on the one or more features of the one or more active order items. The method then leads to comparing, by the processing unit, the ranking score of the one or more active order items with a threshold ranking score. Further, the method encompasses identifying, by the identification unit, the target order item based at least on a successful comparison of a ranking score of a first active order item from the one or more active order items with the threshold ranking score.

Another aspect of the present invention relates to a system for identifying a target order item. The system comprises an identification unit configured to identify, one or more active order items associated with one or more users and one or more features of the one or more active order items. The system further comprises a processing unit configured to determine, a ranking score of the one or more active order items based on the one or more features of the one or more active order items. The processing unit is further configured to compare, the ranking score of the one or more active order items with a threshold ranking score. Also, the identification unit, is further configured to identify, the target order item based at least on a successful comparison of a ranking score of a first active order item from the one or more active order items with the threshold ranking score.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for identifying a target order item, in accordance with exemplary embodiments of the present invention.

FIG. 2 illustrates an exemplary method flow diagram [200], depicting a method for identifying a target order item, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a transceiver unit, an identification unit, a server unit and any other such unit(s) which are capable of implementing the features of the present disclosure.

As used herein the “Transceiver Unit” may include but not limited to a transmitter to transmit data to one or more destinations and a receiver to receive data from one or more sources. Further, the Transceiver Unit may include any other similar unit required to implement the features of the present invention. The transceiver unit may convert data or information to signals and vice versa for the purpose of transmitting and receiving respectively.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, the existing technologies have many limitations and in order to overcome at least some of the limitations of the prior known solutions, the present disclosure provides a solution for identifying a target order item from one or more active order items of one or more users. The target order item is an item a user might be looking for help and the target order item is identified to resolve target order item related queries. The present invention encompasses identifying the target order item through two phases. More specifically, if the target order item is not identified through the first phase, the present invention leads to the second phase for identification of the target order item. In the first phase, the present invention encompasses proactively identifying/predicting an item a user might be looking for help (i.e. the target order item) based on certain features of one or more active order items associated with said user. This identification of the target order item is based on the characteristics/features of order-items that make them more likely to call about e.g. pending refund for a returned item, an item which was supposed to be delivered on the day of calling etc. For identification of an order item as the target order item with high confidence, the present invention also encompasses receiving a confirmation from the user if that is the order he/she is calling for. In cases where identification is not confident enough, the present invention encompasses identifying the target order item through second phase. In second phase the present invention encompasses generating a query for the user, for instance the user is asked a question “Since you've placed more than one order recently, please tell me which one of your orders you're calling about”. The response to this question is recorded and then transcribed to text using ASR. Thereafter, in the second phase, a search proceeds in multiple rounds of textual similarity measures to retrieve a corresponding order (i.e. the target order item), given a user response to the query (i.e. customer utterance) and catalogue attributes of the one or more active order items.

The present invention provides a solution that identifies a target order item (i.e. an item one or more users might be looking for help) from one or more active order items associated with the one or more users. Thus, the present solution eliminates the limitations of the existing solutions which are not efficient to identify the target order item in scenarios where the one or more users are associated with the one or more active order items and the one or more users are looking for help for a specific order item. By identifying the target order item based on the implementation of the present invention, the present invention provides a solution to the technical problem of high degree of recognition and lexical noise associated with NER (named entity recognition) on ASR transcripts. The identification of the target order item based on textual similarity measures is completely unsupervised and works on lexical form of utterances primarily thereby having no dependency on NER. Also, the identification of the target order item based on features of the one or more active order items is independent on what user is speaking on the line. The present solution eliminates the limitations of errors from ASR by handling an impact of ASR noise by phonetic matches.

The present disclosure is further explained in detail below with reference now to the drawings.

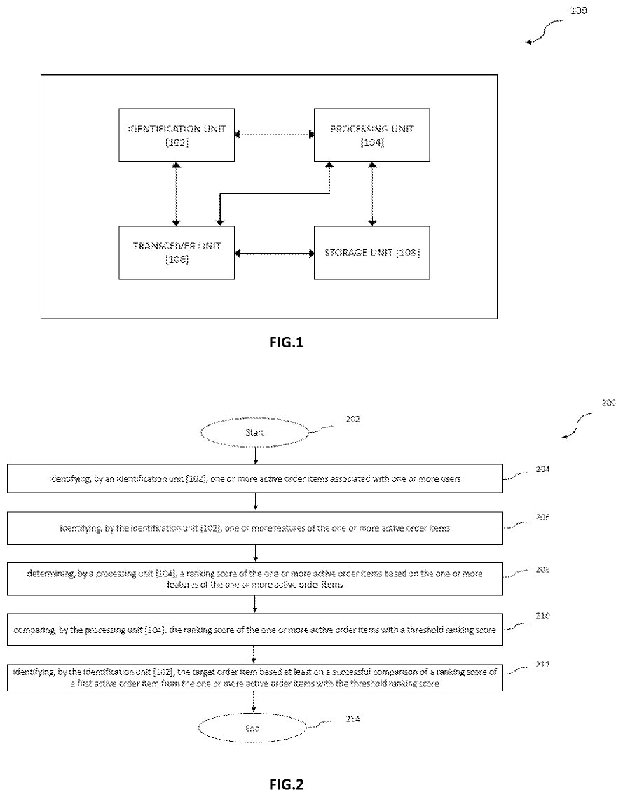

Referring to FIG. 1, an exemplary block diagram of a system [100] for identifying a target order item, in accordance with exemplary embodiments of the present invention is shown. As shown in FIG. 1, the system encompasses at least one identification unit [102], at least one processing unit [104], at least one transceiver unit [106] and at least one storage unit [108]. In an implementation, the system [100] may reside in a server device connected to a user device of one or more users. All of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure.

The system [100] is configured to identify a target order item, with the help of the interconnection between the components/units of the system [100]. The target order item is an ordered item the one or more users need help with.

In order to identify the target order item, the identification unit [102] of the system [100] is configured to identify, one or more active order items associated with one or more users. In an implementation, an active order item is an item ordered by the one or more users via an ecommerce platform and said order item is associated with at least one pending action. For instance an ordered item yet to be delivered, an ordered item to be returned, an ordered item to be replaced, an ordered item associated with any transaction related issue and the like are a few examples of the active order item. The one or more active order items are identified based on one or more query indication from the one or more user. In an implementation the one or more query indication includes one or more incoming calls from the one or more users, wherein said one or more incoming calls are associated with a customer support service of the ecommerce platform. For example, if an incoming call is identified at a customer support service platform of an ecommerce platform, the identification unit [102] is configured to identify one or more order items associated with a user/user account from which the incoming call is associated, wherein said one or more order items are the item(s) for which an order is placed by the user (i.e. one or more active order items).

Further, the identification unit [102] is configured to identify, one or more features of the one or more active order items. The one or more features of the one or more active order items includes various characteristics of item(s) ordered by the one or more users, wherein such characteristics make the item(s) more likely to inquire about. In an implementation the one or more features may include but not limited to at least one of one or more order specific parameters, one or more transaction specific parameters, one or more product specific parameters and one or more self-serve related parameters. These parameters are derived based on one or more raw features of item(s) ordered by the one or more users, wherein the one or more raw features includes but not limited to an ordered date, a delivery due date, an order status, an incident creation date and the like. The one or more order specific parameters comprises parameters indicating at least an order status such as including but not limited to is delivery due today?, is pickup pending?, Is Refund issued?, number of days since order is placed, is there a re-promise event, etc. These features/parameters are specific to the time when the one or more users initiates the one or more query indication (such as a call) towards the customer service support. The one or more transaction specific parameters, includes but not limited to parameters indicting at least one of a price of one or more products, shipping charges of the one or more products, order payment type related to the one or more products and the like.

The one or more product specific parameters comprises parameters indicting catalog attributes including but not limited to a brand name, a vertical, an indication indicating if an ordered item is a large item?, an indication indicating if an ordered product is assured by an e-commerce platform?, etc. These features are not dependent on the time when the one or more users initiates the one or more query indications towards the customer service support. The one or more self-serve related parameters comprises parameters indicting a self-service related event related to the one or more active order items such as including but not limited to at least one of a number of days since last order item related conversation is initiated, a number of days since last visit of the one or more users on my order page, a number of days since last incident creation and the like.

Also, in an implementation, the one or more features of the one or more active order items comprises one or more derived features indicating a relative ordering between various parameters of the one or more active order items of the one or more users. In an example, the one or more derived features includes but not limited to:
a rank of the one or more active order items with respect to a corresponding ordered date, wherein said ranking is determined as the users are more likely to initiate a query for a recent order than older ones, a pending refund indication for one or more other items in a basket, wherein the basket refers to all active order items of the one or more users from which the one or more query indication is received,
an indication of an incident created for the one or more items in the basket in last few days, and
any other such features derived based on at least one of the one or more self-serve related parameters and the one or more order specific parameters, to indicate the relative ordering between the various parameters of the one or more active order items.

As the likelihood of the one or more query indication for the one or more active orders from the one or more users is highly related to the one or more features of all active orders of the one or more users, the relative ordering between the various parameters of the one or more active order items is important. For example, as the chances of customers calling for an item that just got shipped are less when there is another item whose refund is pending for a long time, the relative ordering between features of such shipped item and the item with pending refund is important and therefore the one or more derived features are identified to consider the relationship among parameters of the active order items for better identification of the target order item (i.e. here the item for which the refund is pending for a long time).

Thereafter, the processing unit [104] connected to the identification unit [102] is configured to determine, a ranking score of the one or more active order items based on the one or more features of the one or more active order items. The processing unit [104] is further configured to determine the ranking score of the one or more active order items based on a pre-trained dataset. The pre-trained dataset comprises a plurality of data trained based on at least one of a plurality query indications received at a plurality of customer support service platforms from a plurality of users/customers and a plurality of features associated with a plurality of items ordered by the plurality of users/customers via a plurality of digital platforms associated with such plurality of customer support service platforms. More particularly, the processing unit [104] is configured to analyze the one or more features of the one or more active order items with respect to the pre-trained dataset to determine the ranking score of the one or more active order items.

Thereafter, the processing unit [104] is configured to compare, the ranking score of the one or more active order items with a threshold ranking score. For example, if a threshold ranking score is 1 and a ranking score associated with two items i.e. A and B ordered by a user is 0.5 and 1, respectively. The processing unit [104] is configured to compare the ranking score of A and B i.e. 0.5 and 1, respectively, with the threshold ranking score 1.

Further the identification unit [102] is configured to identify, the target order item based at least on a successful comparison of a ranking score of a first active order item from the one or more active order items with the threshold ranking score. The successful comparison of the ranking score of the first active order item with the threshold ranking score indicates that the ranking score of the first active order item is greater than or equal to the threshold ranking score. Therefore, the first active order item is an order item from the one or more active order items having a ranking score greater than or equal to the threshold ranking score. Considering the above example, where the processing unit [104] is configured to compare the ranking score of the ordered items A and B i.e. 0.5 and 1, respectively, with the threshold ranking score 1, in the given example the ordered item B is identified by the identification unit [102] as the first active order item.

More particularly, to identify, the target order item, a transceiver unit [106] connected to the processing unit [104] and the identification unit [102], is configured to receive a user input from the one or more users based on the successful comparison of the ranking score of the first active order item with the threshold ranking score. The user input is received in response to a confirmation query generated for the one or more users by the processing unit [104], based on the successful comparison of the ranking score of the first active order item with the threshold ranking score. Thereafter the processing unit [104], is configured to generate one of a first positive indication and a first negative indication based on the user input received from the one or more users. The first positive indication is generated by the processing unit [104] based on a receipt of the user input indicating a successful confirmation of the first order item as the target order item. Also, the first negative indication is generated by the processing unit [104] based on a receipt of the user input indicating an unsuccessful confirmation of the first order item as the target order item. Further, in an event where the first positive indication is generated, the identification unit [102], is configured to identify the first active order item as the target order item based on the first positive indication. Considering the above example, where the ordered item B is identified by the identification unit [102] as the first active order item, in the given example the transceiver unit [106] is configured to receive a user input from a user based on the successful comparison of the ranking score of the ordered item B with the threshold ranking score. More specifically, when the ranking score of the ordered item B i.e. 1 is successfully compared with the threshold ranking score i.e. 1, a confirmation query for the same is initiated by the processing unit [104] for the user, and the transceiver unit [106] in response to said confirmation query receives the user input from the user. The user input comprises an indication of one of a successful confirmation of the ordered item B as a target order item (i.e. the item for which the customer has initiated a call) and an unsuccessful confirmation of the ordered item B as the target order item. Thereafter, the processing unit [104] generates one of the first positive indication and the first negative indication based on the received user input. Further, if the positive indication is generated (i.e. if the processing unit [104] confirms based on the user input that the ordered item B is the target order item), the identification unit [102] is configured to identify B as the target order item based on said first positive indication.

Further in an event of generation of the first negative indication, the processing unit [104], is configured to generate a query for the one or more users based on said first negative indication. More particularly, in the event where the user input indicating the unsuccessful confirmation of the first order item as the target order item is received at the transceiver unit [106], the processing unit [104] connected to the transceiver unit [106] is configured to generate the query for the one or more users. In an example, said query includes a voice command indicating “Since you've placed more than one order recently, please tell me which one of your orders you're calling about”.

Once said query is generated, the transceiver unit [106] is then configured to provide, the query to the one or more users. In an example, the generated query is provided to the one or more users as a voice command. Thereafter, the transceiver unit [106] is also configured to receive, at least one response to the query from the one or more users. The at least one response to the query from the one or more users may include but not limited to at least one audio response from the one or more user, wherein such at least one audio response may comprise a detail of an ordered item from the one or more active order items associated with the one or more users.

Generally various generic texts/tokens (like hello, yes, ok and other regional language based generic responses) in various customer utterances are received as the at least one response, which are of no use in retrieving/identifying the target order item. Hence, such commonly used generic texts/tokens are required to be removed from the at least one response to the query received from the one or more users. Also, as by nature of ASR, acronyms are transcribed as single letter split words for e.g., a c for AC, t v for TV, etc. Therefore, the processing unit [104] is configured to process the at least one response. The processing of the at least one response comprises at least one of a removal of at least one generic token from the at least one response and a joining of two or more continuous single letter words identified based on the at least one response. In an implementation, some of the responses to said generated query (i.e. some customer utterances) encompasses only the generic tokens and therefore such responses become blank after the processing by the processing unit [104]. Further, in an implementation such cases with blank processed response are considered to have no match for the target order item from the one or more active order items and discarded. Further, the non-blank processed response are considered as the at least one processed response in the present disclosure, and various similarity measures are implemented on the at least one processed response to identify the target order item.

Further, the identification unit [102], is configured to identify, one or more response related tokens in the at least one processed response. For example, if a processed response is a data indicating—ABC Pro (Aurora Blue, 128 GB) (4 GB), the one or more response related tokens i.e. product name—ABC Pro, colour—Aurora Blue, Memory—128 GB, and 4 GB RAM are identified by the identification unit [102].

Also, the identification unit [102], is further configured to identify, one or more item related tokens in a title of the one or more active order items. Product/Item titles are typically concatenation of brand, model name, colour, etc. For instance—‘CBA Note 11 Pro (Blue, 128 GB) (4 GB RAM)’, ‘XYZ T500BT Bluetooth Headset (Black, On the Ear)’ are some sample product titles. Therefore, in an example the one or more item related tokens such as product name—CBA Note 11 Pro, colour—Blue, Memory—128 GB, and 4 GB RAM are identified by the identification unit [102] from the product title—CBA Note 11 Pro (Blue, 128 GB) (4 GB RAM).

Thereafter, the processing unit [104], is configured to compare the one or more response related tokens and the one or more item related tokens. The processing unit [104] is then configured to assign, a score to the one or more active order items based on the comparison of the one or more response related tokens and the one or more item related tokens. Further, the processing unit [104], is configured to generate, one of a second positive indication and a second negative indication based on the score assigned to the one or more active order items. The second positive indication is generated based on at least one of a successful identification of an order item associated with a target score from the one or more active order items and a successful identification of an order item associated with a score less than the target score, in an event the one or more active order items includes a single item. For example, if in an event, response related tokens are identified as—“CBA Note 11 Pro”, “(Blue, 128 GB)” and “(4 GB RAM)”, and item related tokens are identified as—“CBA Note 11 Pro”, “(Blue, 128 GB)” and “(4 GB RAM)”, the processing unit [104] in such event is configured to assign to an order item having a title associated with the identified item related tokens, a score 1 based on the comparison of said response related tokens and said item related tokens, wherein 1 indicated a 100% match. Also, as the assigned score of the order item related to the title comprising the item related tokens is same as that of the target score, the processing unit [104] generates the second positive indication. Further, in the given example, if in an event where only a single order item is associated with a user and a assigned score of said single order item is less than 1 (i.e. the assigned score of said single order item is less than the target score), in such event also, the processing unit [104] generates the second positive indication.

The second negative indication is generated based on at least one of an unsuccessful identification of the order item associated with the target score, from the one or more active order items and an unsuccessful identification of the order item associated with the score less than the target score, in an event the one or more active order items includes the single item. For example, if in an event, response related tokens are identified as—“CBA Pro”, “ (128 GB)” and “(4 GB)” and item related tokens are identified as—“CBA Note 11 Pro” “ (Blue, 128 GB)” and “(4 GB RAM)”, the processing unit [104] in such event is configured to assign to an order item related to a title associated with the item related tokens from multiple active order items, a score less than 1 based on a comparison of said response related tokens and said item related tokens, wherein 1 indicated a 100% match. Also, in the given example the target score is 1. Further, as the assigned score of the order item related to the title comprising the item related tokens is different from that of the target score, the processing unit [104] generates the second negative indication. Further, in the given example, if multiple order items are associated with a user initiating a query indication and an assigned score of the order item is less than 1 (i.e. the assigned score of the order item related to the title comprising the item related tokens is less than the target score), in such event also, the processing unit [104] generates the second negative indication. Thereafter, the identification unit [102], is configured to identify the target order item from the one or more active order items based on the second positive indication. More particularly, in case of at least one of the successful identification of the order item associated with the target score, from the one or more active order items and the successful identification of the order item associated with the score less than the target score in an event the one or more active order items includes a single item, the identification unit [102] is configured to identify said order item associated with the target score and said order item associated with the score less than the target score, as the target order item, respectively.

Furthermore, in an implementation, the score assigned to the one or more active order items can be determined as follows:

Let q denote a pre-processed customer/user response composed of response related tokens. Let {pᵢ}ᵢ₌₁^{P} denote a list of active order items where pᵢ denote a product title corresponding to i^{th} order item. Score for the i^{th} product/order item is obtained as:

$${s}_{i} = \frac{1}{\vert q \vert} {\sum }_{x : q}^{1} \{ y : y ∈ {p}_{i} , y == x \} != ϕ$$

where lₓ indicates an indicator function which is 1 if x is true else 0. The summation indicates an overall response related tokens and the indicator function indicates whether a particular response related token x matches with any of the tokens of product title pᵢ (i.e. item related token(s)). The one or more active order items/Product(s) with maximum score are considered a possible candidate product(s)/active order item(s) for a direct or 100% match (i.e. possible candidate product(s)/active order item(s) associated with the target score). Further, in the given implementation, the direct match between the at least one processed response and any of the ordered item from the one or more active order items is said to occur in the following cases:
Score of 1, indicating that a product title of the ordered item(s) from the one or more active order items includes all response related tokens. Hence if the maximum score is 1, all order item(s) with the score of 1 are identified as the direct or 100% match (i.e. possible candidate product(s)/active order item(s) associated with the target score), and
If in an event a max score is less than 1, the direct match (possible candidate product(s)/active order item(s) associated with the target score) is limited to a single order item retrieval so as to avoid false possible candidate product(s)/active order item(s) indicating an association with the target score.

Further, based on such direct or 100% match (i.e. the possible candidate product(s)/active order item(s) associated with the target score), the identification unit [102] is configured to identify the target order item from the one or more active order items.

Further, in an implementation the processing unit [104] is also configured to determine, one or more phonetic representation of the one or more item related tokens. In an example, to determine the one or more phonetic representation, strings like ‘mam record’, ‘memory card’, ‘double back’, ‘duffel bag’ are mapped to ‘MANRA-CAD’, ‘MANARACAD’, ‘DABLABAC’ and ‘DAFALBAG’ respectively.

Thereafter, the processing unit [104], is configured to compare, the one or more response related tokens with the one or more phonetic representation of the one or more item related tokens. The processing unit [104] is then configured to determine, a similarity score associated with the one or more active order items based on the comparison of the one or more response related tokens with the one or more phonetic representation of the one or more item related tokens. The similarity score associated with the one or more active order items is directly proportional to a degree of successful comparison of the one or more response related tokens with the one or more phonetic representation of the one or more item related tokens.

Thereafter, the identification unit [102], is configured to identify the target order item from the one or more active order items based on the similarity score associated with the one or more active order items. In an implementation, an active order item having a maximum similarity score from the one or more active order items, is identified by the identification unit [102] as the target order item. More particularly, ASR errors on product specific tokens (i.e. item related tokens) imposes additional challenges in identifying a corresponding order item. For example, ‘AB see hot 94’ for ‘ABC Hot 9 Pro’, ‘mam record’ for ‘memory card’, ‘very machine’ for ‘weighing machine’, ‘double back’ for ‘duffel bag’, etc. Therefore, to handle such scenarios, a similarity between phonetic representations of n-grams of the products'/the one or more active order items' title with that of the at least one processed response (such as processed customer utterance(s)) is considered by the processing unit [104] to determine the similarity score associated with the one or more active order items, in order to further identify the target order item. Further in an event of generation of the second negative indication, the identification unit [102], is configured to identify, one or more tokens related to a partial product utterance in the at least one processed response based on the second negative indication. More particularly, the identification unit [102] is configured to identify, the one or more tokens related to a partial product utterance in the at least one processed response in an event of at least one of the unsuccessful identification of the order item associated with the target score, from the one or more active order items and the unsuccessful identification of the order item associated with the score less than the target score in the scenario where the one or more active order items includes the single item.

The processing unit [104] is thereafter configured to compare, the one or more tokens related to partial product utterance and the one or more item related tokens. Further the processing unit [104] is configured to determine, a partial similarity score associated with the one or more active order items based on the comparison of the one or more tokens related to the partial product utterance and the one or more item related tokens. The partial similarity score associated with the one or more active order items is directly proportional to a degree of successful comparison of the one or more tokens related to the partial product utterance with the one or more item related tokens.

The identification unit [102], is further configured to identify the target order item from the one or more active order items based on the partial similarity score associated with the one or more active order items. Furthermore, such identification of the target order item from the one or more active order items is further based on at least one of an identification of an order item associated with a target partial similarity score, from the one or more active order items and an identification of an order item associated with a score less than the target partial similarity score, in an event the one or more active order items includes the single item.

In an example, in order to identify the target order item from the one or more active order items based on the partial similarity score associated with the one or more active order items, one or more tokens related to a partial product utterances like ‘fridge’ for ‘refrigerator’, ‘watch’ for ‘smart watch’ and ASR misspelled utterances like ‘sandel’ for ‘sandal’ are considered. Furthermore, a partial similarity score between n-Grams from the at least one processed response (i.e. the one or more tokens related to a partial product utterances) and the titles of the one or more active order items (i.e. the one or more item related tokens) is determined. In an implementation the process of determining of the partial similarity score is initiates with individual tokens related to the partial product utterances and then moves to bigram, trigram, etc. till n-Gram. Match at a higher N is more promising than a lower N. Further in an example, a customer could ask for ‘ABC wired headset’ and the active orders could include ‘XYZ Wired Headset’ and a ‘ABC Wired Headset’. In such cases, token similarity or bigram similarity might treat both of these headsets as matching items, however trigram similarity would result in a correct match. i.e., for cases with similar products in the active order items, going for a higher N helps to reduce the false results if the customer provides specified additional details to narrow the results.

Also, in an implementation, matching active order item(s) (i.e. the order item(s) associated with a target partial similarity score) can be determined as below:

Let Q′ₙ refer to an n-grams in a processed response having a match with any of the active order item n-grams, ngrams represent a parameter to provide all possible n-grams and ngrams′ provides parameters of the surrounding n-grams of Q′ₙ₋₁. For n≥2, Qₙ would only contain n-grams with one or more item related tokens. At a particular N, a similarity score sᵢ for each active order item is obtained, based on the proportion of n-grams in Qₙ, that finds a match with n-grams in corresponding active order items' titles and the active order item(s) with maximum score (i.e. the active order item(s) associated with the target partial similarity score, from the one or more active order items) are considered as candidate items (\hat{p}) for a successful match. At any N, matching active order item(s) is said to have found in the following cases:
N-grams from any active order item finds a match with all n-grams included in Qₙ i.e., max(si)==1. And
There is only one candidate product i.e., |\hat{p}|==1.

In an event if none of the active order items finds a match at higher N, the matched active order item(s) as of level N−1 is considered.

Also, in an implementation, the identification unit [102] is also configured to identify, the target order item from the one or more active order items based on one or more vertical names associated with the one or more active order items and the partial similarity score associated with the one or more active order items. As, the one or more users can provide the at least one response in a variety of ways to provide details of an active order item, wherein such details might not just the terms as indicated in a title of said active order item. For example, a possible valid user response/customer utterance could be “for a mobile order”, but most product titles of mobile phones do not specify that it's a mobile (such as ‘ABC Note9 Pro Ultra’, ‘CBA A2 Pro Green, 64 GB’). Therefore, in an implementation the one or more vertical names associated with the one or more active order items are also used by the identification unit [102] to identify, the target order item from the one or more active order items. Further, the use of one or more vertical names may increase possible false identification of the target order item because of one or more irrelevant terms present in the at least one response received from the one or more users. For example, a response received from a user—‘dumbel product ke liye phone kiya hai’ can be matched to a headphone vertical as well, therefore, to avoid such issues, the partial similarity score associated with the one or more active order items are also used by the identification unit [102] along with the one or more vertical names associated with the one or more active order items, to identify the target order item.

Furthermore, in an implementation, the identification of the target order item from the one or more active order items based on the one or more phonetic representation of the one or more item related tokens is achieved in a similar manner of the identification of the target order item from the one or more active order items based on the one or more tokens related to the partial product utterance, however the major difference in both the implementations is that the similarity score associated with the one or more active order items is determined based on phonetic representation of n-grams, to identify the target order item.

Furthermore, in an event if no target order item is identified based on the partial similarity score associated with the one or more active order items, the processing unit [104] is configured to identify the target order item based on a receipt of a user confirmation for the target order item from the one or more users. The user confirmation is received in response to providing the one or more users an option to select the one or more active order items. The options are provided to the one or more users in an order according to the ranking score of the one or more active order items. For example, if there are 2 active order items X and Y are associated with a ranking score 0.5 and 1, the processing unit [104] provides the information of Y to the one or more users as an option to select Y as the target order item followed by providing the information related to X if Y is not identified as the target order item based on the user confirmation.

Referring to FIG. 2, an exemplary method flow diagram [200], depicting a method for identifying a target order item, in accordance with exemplary embodiments of the present invention is shown. In an implementation the method is performed by a system [100], wherein the system [100] may be implemented on a server unit. As shown in FIG. 2, the method begins at step [202].

At step [204] the method comprises identifying, by an identification unit [102], one or more active order items associated with one or more users. In an implementation, an active order item is an item ordered by the one or more users via an ecommerce platform and said order item is associated with at least one pending action. For instance an ordered item yet to be delivered, an ordered item to be returned, an ordered item to be replaced, an ordered item associated with any transaction related issue and the like are a few examples of the active order item. The one or more active order items are identified based on one or more query indication from the one or more user. In an implementation the one or more query indication includes one or more incoming calls from the one or more users, wherein said one or more incoming calls are initiated for a customer support service of the ecommerce platform. For example, if an incoming call is identified at a customer support service platform of an ecommerce platform, the method encompasses identifying by the identification unit [102], one or more order items/items associated with a user/user account from which the incoming call is associated, wherein said one or more order items are the item(s) for which an order is placed by the user (i.e. one or more active order items) on the ecommerce platform.

Next, at step [206] the method comprises identifying, by the identification unit [102 ], one or more features of the one or more active order items. The one or more features of the one or more active order items includes various characteristics of item(s) ordered by the one or more users, wherein such characteristics make the item(s) more likely to inquire about. In an implementation the one or more features may include but not limited to at least one of one or more order specific parameters, one or more transaction specific parameters, one or more product specific parameters and one or more self-serve related parameters. These parameters are derived based on one or more raw features of item(s) ordered by the one or more users, wherein the one or more raw features includes but not limited to an ordered date, a delivery due date, an order status, an incident creation date and the like. The one or more order specific parameters comprises parameters indicating at least an order status such as including but not limited to is delivery due today?, is pickup pending?, Is Refund issued?, number of days since order is placed, is there a re-promise event, etc. These features/parameters are specific to the time when the one or more users initiates the one or more query indication (such as a call) towards the customer service support. The one or more transaction specific parameters, includes but not limited to parameters indicting at least one of a price of one or more products, shipping charges of the one or more products, order payment type related to the one or more products and the like.

The one or more product specific parameters comprises parameters indicting catalog attributes including but not limited to a brand name, a vertical, an indication indicating if an ordered item is a large item?, an indication indicating if an ordered product is assured by an e-commerce platform?, etc. These features are not dependent on the time when the one or more users initiates the one or more query indications towards the customer service support. The one or more self-serve related parameters comprises parameters indicting a self-service related event related to the one or more active order items such as including but not limited to at least one of a number of days since last order item related conversation is initiated, a number of days since last visit of the one or more users on my order page, a number of days since last incident creation and the like.

Also, in an implementation, the one or more features of the one or more active order items comprises one or more derived features indicating a relative ordering between various parameters of the one or more active order items of the one or more users. In an example, the one or more derived features includes but not limited to:
a rank of the one or more active order items with respect to a corresponding ordered date, wherein said ranking is determined as the user(s) are more likely to initiate a query for a recent order than older ones, a pending refund indication for one or more other items in a basket,
wherein the basket refers to all active order items of the one or more users from which the one or more query indication is received,
an indication of an incident created for the one or more items in the basket in last few days, and
any other such features derived based on at least one of the one or more self-serve related parameters and the one or more order specific parameters, to indicate the relative ordering between the various parameters of the one or more active order items.

As the likelihood of the one or more query indication for the one or more active orders from the one or more users is highly related to the one or more features of all active orders of the one or more users, the relative ordering between the various parameters of the one or more active order items is important. For example, as the chances of user(s) calling for an item that just ordered by the user(s) are less when there is another item whose refund is pending for a long time, the relative ordering between features of such ordered item and the item with pending refund is important and therefore the one or more derived features are identified to consider the relationship among parameters of the active order items for better identification of the target order item.

Further, at step [208] the method comprises determining, by a processing unit [104 ], a ranking score of the one or more active order items based on the one or more features of the one or more active order items. Also, the process of determining, by a processing unit [104], a ranking score of the one or more active order items is further based on a pre-trained dataset. The pre-trained dataset comprises a plurality of data trained based on at least one of a plurality query indications received at a plurality of customer support service platforms from a plurality of users/customers and a plurality of features associated with a plurality of items ordered by the plurality of users/customers via a plurality of digital platforms associated with such plurality of customer support service platforms. More particularly, the method encompasses analyzing by the processing unit [104], the one or more features of the one or more active order items with respect to the pre-trained dataset to determine the ranking score of the one or more active order items.

Next, at step [210] the method comprises comparing, by the processing unit [104], the ranking score of the one or more active order items with a threshold ranking score. For example, if a threshold ranking score is 1 and a ranking score associated with two items/ordered items i.e. X and Y ordered by a user is 0.75 and 1, respectively. The method in such event encompasses comparing by the processing unit [104], the ranking score of X and Y i.e. 0.75 and 1, respectively, with the threshold ranking score 1.

Thereafter, at step [212] the method comprises identifying, by the identification unit [102], the target order item based at least on a successful comparison of a ranking score of a first active order item from the one or more active order items with the threshold ranking score. The successful comparison of the ranking score of the first active order item with the threshold ranking score indicates that the ranking score of the first active order item is greater than or equal to the threshold ranking score. Therefore, the first active order item is an order item from the one or more active order items having a ranking score greater than or equal to the threshold ranking score. Considering the above example, where the ranking score of the ordered items X and Y i.e. 0.75 and 1, respectively, are compared with the threshold ranking score 1, in the given example, the method further encompasses identifying by the identification unit [102], the ordered item Y as the first active order item.

More particularly, the process of identifying, by the identification unit [102], the target order item comprises receiving, at a transceiver unit [106], a user input from the one or more users based on the successful comparison of the ranking score of the first active order item with the threshold ranking score. The user input is received in response to a confirmation query generated for the one or more users by the processing unit [104], based on the successful comparison of the ranking score of the first active order item with the threshold ranking score. The method thereafter leads to generating, by the processing unit [104], one of a first positive indication and a first negative indication based on the user input. The first positive indication is generated by the processing unit [104] based on a receipt of the user input indicating a successful confirmation of the first order item as the target order item. Also, the first negative indication is generated by the processing unit [104] based on a receipt of the user input indicating an unsuccessful confirmation of the first order item as the target order item.

Further, in an event where the first positive indication is generated, the method encompasses identifying, by the identification unit [102], the first active order item as the target order item based on the first positive indication. Considering the above example, where the ordered item Y is identified by the identification unit [102] as the first active order item, in the given example the method encompasses receiving at the transceiver unit [106], a user input from a user based on the successful comparison of the ranking score of the ordered item Y with the threshold ranking score. More specifically, when the ranking score of the ordered item Y i.e. 1 is successfully compared with the threshold ranking score i.e. 1, a confirmation query for the same is initiated by the processing unit [104] for the user, and the transceiver unit [106] in response to said confirmation query receives the user input from the user. The user input comprises an indication of one of a successful confirmation of the ordered item Y as a target order item (i.e. the item for which the customer has initiated a call) and an unsuccessful confirmation of the ordered item Y as the target order item. Thereafter, the method encompasses generating by the processing unit [104], one of the first positive indication and the first negative indication based on the received user input. Further, if the positive indication is generated (i.e. if the processing unit [104] confirms based on the user input that the ordered item Y is the target order item), the method encompasses identifying by the identification unit [102], Y as the target order item based on said first positive indication.

Further in an event of generation of the first negative indication, the method comprises generating, by the processing unit [104], a query for the one or more users based on the first negative indication. More particularly, in the event where the user input indicating the unsuccessful confirmation of the first order item as the target order item is received at the transceiver unit [106], the method via the processing unit [104] connected to the transceiver unit [106] encompasses generating the query for the one or more users. In an example, said query includes a voice command indicating “Since you've placed more than one order recently, please tell me which one of your orders you're calling about”.

Once said query is generated, the method then leads to providing, by the transceiver unit [106], the query to the one or more users. In an example, the generated query is provided to the one or more users as a voice command. Thereafter, the method encompasses receiving, at the transceiver unit [106], at least one response to the query from the one or more users. The at least one response to the query from the one or more users may include but not limited to at least one audio response from the one or more user, wherein such at least one audio response may comprise a detail of an ordered item from the one or more active order items associated with the one or more users.

Generally various generic texts/tokens (like hello, yes, ok, hi, no, what and other regional language based generic responses) of various customer utterances are received as the at least one response, which are of no use in retrieving/identifying the target order item. Hence, such commonly used generic texts/tokens are required to be removed from the at least one response to the query received from the one or more users. Also, as by nature of ASR, acronyms are transcribed as single letter split words for e.g., a c for AC, t v for TV, etc. Therefore, the method encompasses processing by the processing unit [104], the at least one response, wherein processing the at least one response further comprises at least one of a removal of at least one generic token from the at least one response and joining of two or more continuous single letter words identified based on the at least one response. In an implementation, some of the responses to said generated query (i.e. some customer utterances) encompasses only the generic tokens and therefore such responses become blank after the processing by the processing unit [104]. Further, in an implementation such cases with blank processed response are considered to have no match for the target order item from the one or more active order items and discarded. Further, the non-blank processed response are considered as the at least one processed response in the present disclosure, and various similarity measures are implemented on the at least one processed response to identify the target order item.

The method thereafter leads to identifying, by the identification unit [102], one or more response related tokens in the at least one processed response. For example, if a processed response is a data indicating—XYZ Pro (Blue, 128 GB) (4 GB), the one or more response related tokens i.e. product name—XYZ Pro, colour—Blue, Memory—128 GB, and 4 GB RAM are identified by the identification unit [102].

Also, the method then encompasses identifying, by the identification unit [102], one or more item related tokens in a title of the one or more active order items. For instance—‘ZYX Note 11 Pro (Green, 128 GB) (4 GB RAM)’, ‘CBA T500BT Bluetooth Headset (Black, On the Ear)’ are some sample product titles. Therefore, in an example the one or more item related tokens such as product name—ZYX Note 11 Pro, colour—Green, Memory—128 GB, and 4 GB RAM are identified by the identification unit [102] from the product title—ZYX Note 11 Pro (Green, 128 GB) (4 GB RAM)’.

Further, the method encompasses comparing, by the processing unit [104], the one or more response related tokens and the one or more item related tokens. Thereafter, the method leads to assigning, by the processing unit [104], a score to the one or more active order items based on the comparison of the one or more response related tokens and the one or more item related tokens.

Thereafter, the method comprises generating, by the processing unit [104], one of a second positive indication and a second negative indication based on the score assigned to the one or more active order items. The second positive indication is generated based on at least one of a successful identification of an order item associated with a target score, from the one or more active order items and a successful identification of an order item associated with a score less than the target score, in an event the one or more active order items includes a single item. For example, if in an event, response related tokens are identified as—“ABC Note 11 Pro”, “(Green, 128 GB)” and “(4 GB RAM)”, and item related tokens are identified as—“ABC Note 11 Pro”, “(Green, 128 GB)” and “(4 GB RAM)”, the method via the processing unit [104] in such event, assigns to an order item having a title associated with the identified item related tokens, a score 1 based on the comparison of said response related tokens and said item related tokens, wherein 1 indicated a 100% match. Also, as the assigned score of the order item related to the title comprising the item related tokens is same as that of the target score, the method encompasses generating by the processing unit [104], the second positive indication. Further, in the given example, if in an event where only a single order item is associated with a user and a assigned score of said single order item is less than 1 (i.e. the assigned score of said single order item is less than the target score), in such event also, the method encompasses generating by the processing unit [104] the second positive indication.

The second negative indication is generated based on at least one of an unsuccessful identification of the order item associated with the target score, from the one or more active order items and an unsuccessful identification of the order item associated with the score less than the target score, in an event the one or more active order items includes the single item. For example, if in an event, response related tokens are identified as—“ABC Pro”, “(128 GB)” and “(4 GB)” and item related tokens are identified as—“ABC Note 11 Pro” “(Blue, 128 GB)” and “(4 GB RAM)”, in such event the method via the processing unit [104] encompasses assigning to an order item related to a title associated with the item related tokens from multiple active order items, a score less than 1 based on a comparison of said response related tokens and said item related tokens, wherein 1 indicated a 100% match. Also, in the given example the target score is 1. Further, as the assigned score of the order item related to the title comprising the item related tokens is different from that of the target score, the processing unit [104] generates the second negative indication. Further, in the given example, if multiple order items are associated with a user initiating a query indication and an assigned score of the order item is less than 1 (i.e. the assigned score of the order item related to the title comprising the item related tokens is less than the target score), in such event also, the method encompasses generating by the processing unit [104], the second negative indication.

Further, the method encompasses identifying, by the identification unit [102], the target order item from the one or more active order items based on the second positive indication. More particularly, in case of at least one of the successful identification of the order item associated with the target score, from the one or more active order items and the successful identification of the order item associated with the score less than the target score in an event the one or more active order items includes a single item, the method encompasses identifying by the identification unit [102], said order item associated with the target score and said order item associated with the score less than the target score, as the target order item, respectively.

Furthermore, in an implementation, the score assigned to the one or more active order items can be determined as follows:

Let q denote a pre-processed customer/user response composed of response related tokens. Let {pᵢ}ᵢ₌₁^{p} denote a list of active order items where pᵢ denote a product title corresponding to i^{th} order item. Score for the i^{th} product/order item is obtained as:

$${s}_{i} = \frac{1}{\vert q \vert} {\sum }_{x : q}^{1} \{ y : y ∈ {p}_{i} , y == x \} != ϕ$$

where lₓ indicates an indicator function which is 1 if x is true else 0. The summation indicates an overall response related tokens and the indicator function indicates whether a particular response related token matches with any of the tokens of product title pᵢ (i.e. item related token(s)). The one or more active order items/Product(s) with maximum score are considered a possible candidate product(s)/active order item(s) for a direct or 100% match (i.e. possible candidate product(s)/active order item(s) associated with the target score). Further, in the given implementation, the direct match between the at least one processed response and any of the ordered item from the one or more active order items is said to occur in the following cases:
Score of 1, indicating that a product title of the ordered item(s) from the one or more active order items includes all response related tokens. Hence if the maximum score is 1, all order item(s) with the score of 1 are identified as the direct or 100% match (i.e. possible candidate product(s)/active order item(s) associated with the target score), and
If in an event a max score is less than 1, the direct match (possible candidate product(s)/active order item(s) associated with the target score) is limited to a single order item retrieval so as to avoid false possible candidate product(s)/active order item(s) indicating an association with the target score.

Further, based on such direct or 100% match (i.e. the possible candidate product(s)/active order item(s) associated with the target score), the method encompasses identifying by the identification unit [102], the target order item from the one or more active order items.

Further, in an implementation the method also encompasses determining, by the processing unit [104], one or more phonetic representation of the one or more item related tokens. In an example, to determine the one or more phonetic representation, strings like ‘mam record’, ‘memory card’, ‘double back’, ‘duffel bag’ are mapped to ‘MANRA-CAD’, ‘MANARACAD’, ‘DABLABAC’ and ‘DAFALBAG’ respectively.

The method thereafter leads to comparing, by the processing unit [104], the one or more response related tokens with the one or more phonetic representation of the one or more item related tokens. Further the method encompasses determining, by the processing unit [104], a similarity score associated with the one or more active order items based on the comparison of the one or more response related tokens with the one or more phonetic representation of the one or more item related tokens. The similarity score associated with the one or more active order items is directly proportional to a degree of successful comparison of the one or more response related tokens with the one or more phonetic representation of the one or more item related tokens.

The method thereafter comprises identifying, by the identification unit [102], the target order item from the one or more active order items based on the similarity score associated with the one or more active order items. In an implementation, an active order item having a maximum similarity score from the one or more active order items, is identified by the identification unit [102] as the target order item.

More particularly, ASR errors on product specific tokens (i.e. item related tokens) imposes additional challenges in identifying a corresponding order item. For example, ‘see bee A hot 94’ for ‘CBA Hot 9 Pro’, ‘mam record’ for ‘memory card’, ‘very machine’ for ‘weighing machine’, ‘double back’ for ‘duffel bag’, etc. Therefore, to handle such scenarios, a similarity between phonetic representations of n-grams of the products'/the one or more active order items' title with that of the at least one processed response (such as processed customer utterance(s)) is considered by the processing unit [104] to determine the similarity score associated with the one or more active order items, in order to further identify the target order item.

Further, in an event of generation of the second negative indication, the method encompasses identifying by the identification unit [102], one or more tokens related to a partial product utterance in the at least one processed response based on the second negative indication. More particularly, the method encompasses identifying by the identification unit [102], the one or more tokens related to a partial product utterance in the at least one processed response in an event of at least one of the unsuccessful identification of the order item associated with the target score, from the one or more active order items and the unsuccessful identification of the order item associated with the score less than the target score in the scenario where the one or more active order items includes the single item.

Further, the method leads to comparing, by the processing unit [104], the one or more tokens related to partial product utterance and the one or more item related tokens. The method thereafter encompasses determining, by the processing unit [104], a partial similarity score associated with the one or more active order items based on the comparison of the one or more tokens related to the partial product utterance and the one or more item related tokens. The partial similarity score associated with the one or more active order items is directly proportional to a degree of successful comparison of the one or more tokens related to the partial product utterance with the one or more item related tokens.

Further the method leads to identifying, by the identification unit [102], the target order item from the one or more active order items based on the partial similarity score associated with the one or more active order items. The identification of the target order item from the one or more active order items is further based on at least one of an identification of an order item associated with a target partial similarity score, from the one or more active order items and an identification of an order item associated with a score less than the target partial similarity score, in an event the one or more active order items includes the single item. Furthermore, the order item associated with the target partial similarity score have a partial similarity score equal to the target partial similarity score.

In an example, in order to identify the target order item from the one or more active order items based on the partial similarity score associated with the one or more active order items, one or more tokens related to a partial product utterances like ‘phone for ‘smartphone, ‘band’ for ‘smart band’ and ASR misspelled utterances like ‘sander for ‘sandal’ are considered. Furthermore, a partial similarity score between n-Grams from the at least one processed response (i.e. the one or more tokens related to a partial product utterances) and the titles of the one or more active order items (i.e. the one or more item related tokens) is determined. In an implementation the process of determining of the partial similarity score is initiates with individual tokens related to the partial product utterances and then moves to bigram, trigram, etc. till n-Gram. Match at a higher N is more promising than a lower N. Further in an example, if a customer asks for ‘XYZ wired headset’ and the active orders includes ‘XYZ Wired Headset’ and a ‘ABC Wired Headset’. In such cases, token similarity or bigram similarity might treat both of these headsets as matching items, however trigram similarity results in a correct match. i.e., for cases with similar products in the active order items, going for a higher N helps to reduce the false results if the customer provides specified additional details to narrow the results.

Also, in an implementation, matching active order item(s) (i.e. the order item(s) associated with a target partial similarity score) can be determined as below:

Let Q′ₙ refer to an n-grams in a processed response having a match with any of the active order item n-grams, ngrams represent a parameter to provide all possible n-grams and ngrams′ provides parameters of the surrounding n-grams of Q′ₙ₋₁. For n≥2, Qₙ would only contain n-grams with one or more item related tokens. At a particular N, a similarity score sᵢ for each active order item is obtained, based on the proportion of n-grams in Qₙ, that finds a match with n-grams in corresponding active order items' titles and the active order item(s) with maximum score (i.e. the active order item(s) associated with the target partial similarity score, from the one or more active order items) are considered as candidate items (\hat{p}) for a successful match. At any N, matching active order item(s) is said to have found in the following cases:
N-grams from any active order item finds a match with all n-grams included in Qₙ, i.e., max(si)==1. And
There is only one candidate product i.e., |\hat{p}|==1.

In an event if none of the active order items finds a match at higher N, the matched active order item(s) as of level N−1 is considered.

Also, in an implementation the method encompasses identifying, by the identification unit [102], the target order item from the one or more active order items based on one or more vertical names associated with the one or more active order items and the partial similarity score associated with the one or more active order items. As, the one or more users can provide the at least one response in a variety of ways to provide details of an active order item, wherein such details might not just the terms as indicated in a title of said active order item. For example, a possible valid user response/customer utterance could be “mobile order k liye”, but most product titles of mobile phones do not specify that it's a mobile. Therefore, in an implementation the one or more vertical names associated with the one or more active order items are also used by the identification unit [102] to identify, the target order item from the one or more active order items. Further, the use of one or more vertical names may increase possible false identification of the target order item because of a presence of one or more terms irrelevant to the vertical name(s), in the at least one response received from the one or more users. For example, a response received from a user—‘HHH product ke liye phone kiya hai’ can be matched to a headphone vertical as well, therefore, to avoid such issues, the partial similarity score associated with the one or more active order items are also used by the identification unit [102] along with the one or more vertical names associated with the one or more active order items, to identify the target order item.

Furthermore, in an implementation, the identification of the target order item from the one or more active order items based on the one or more phonetic representation of the one or more item related tokens is achieved in a similar manner of the identification of the target order item from the one or more active order items based on the one or more tokens related to the partial product utterance, however the major difference in both the implementations is that the similarity score associated with the one or more active order items is determined based on phonetic representation of n-grams, to identify the target order item.

Furthermore, in an event if no target order item is identified based on the above method implementations, the method encompasses identifying by the processing unit [104], the target order item based on a receipt of a user confirmation for the target order item from the one or more users. The user confirmation is received in response to providing the one or more users an option to select the one or more active order items. The options are provided to the one or more users in an order according to the ranking score of the one or more active order items. For example, if there are 2 active order items A and B are associated with a ranking score 0.5 and 1, the method via the processing unit [104] provides the information of B to the one or more users as an option to select B as the target order item followed by providing such option related to A if B is not identified as the target order item based on the user confirmation.

The method thereafter terminates at step [214].

As is evident from the above disclosure, the present invention provides a novel solution for identifying a target order item from one or more one or more active order items associated with one or more users, wherein the target order item is an item for which the one or more users initiated one or more query indication towards a customer service support platform. Therefore, present invention provides a solution that identifies the target order item (i.e. an item one or more users might be looking for help) from the one or more active order items associated with the one or more users. Thus, the present solution eliminates the limitations of the existing solutions which are not efficient to identify the target order item in scenarios where the one or more users are associated with the one or more active order items and the one or more users are looking for help for a specific order item. By identifying the target order item based on the implementation of the present invention, the present invention provides a solution to the technical problem of high degree of recognition and lexical noise associated with NER (named entity recognition) on ASR transcripts. The identification of the target order item based on textual similarity measures is completely unsupervised and works on lexical form of utterances primarily thereby having no dependency on NER. Also, the identification of the target order item based on features of the one or more active order items is independent on what user is speaking on the line. The present solution eliminates the limitations of errors from ASR by handling an impact of ASR noise by phonetic matches.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for identifying a target order item, the method comprising:
identifying, by an identification unit [102], one or more active order items associated with one or more users;
identifying, by the identification unit [102], one or more features of the one or more active order items;
determining, by a processing unit [104], a ranking score of the one or more active order items based on the one or more features of the one or more active order items;
comparing, by the processing unit [104], the ranking score of the one or more active order items with a threshold ranking score; and
identifying, by the identification unit [102], the target order item based at least on a successful comparison of a ranking score of a first active order item from the one or more active order items with the threshold ranking score.

2. The method as claimed in claim 1, wherein the one or more active order items are identified based on one or more query indication from the one or more user.

3. The method as claimed in claim 1, wherein determining, by a processing unit [104], a ranking score of the one or more active order items is further based on a pre-trained dataset.

4. The method as claimed in claim 1, wherein the identifying, by the identification unit [102], the target order item further comprises:
receiving, at a transceiver unit [106], a user input from the one or more users based on the successful comparison of the ranking score of the first active order item with the threshold ranking score;
generating, by the processing unit [104], one of a first positive indication and a first negative indication based on the user input; and
identifying, by the identification unit [102], the first active order item as the target order item based on the first positive indication.

5. The method as claimed in claim 1, wherein the first positive indication is generated by the processing unit [104] based on a receipt of the user input indicating a successful confirmation of the first order item as the target order item.

6. The method as claimed in claim 1, wherein the first negative indication is generated by the processing unit [104] based on a receipt of the user input indicating an unsuccessful confirmation of the first order item as the target order item.

7. The method as claimed in claim 1, the method comprising:
generating, by the processing unit [104], a query based on the first negative indication;
providing, by the transceiver unit [106], the query to the one or more users; and
receiving, at the transceiver unit [106], at least one response to the query from the one or more users.

8. The method as claimed in claim 7, the method comprising processing the at least one response, wherein processing the at least one response further comprises at least one of:
removal of, at least one generic token from the at least one response; and
joining, two or more continuous single letter words identified based on the at least one response.

9. The method as claimed in claim 8, the method comprising:
identifying, by the identification unit [102], one or more response related tokens in the at least one processed response;
identifying, by the identification unit [102], one or more item related tokens in a title of the one or more active order items;
comparing, by the processing unit [104], the one or more response related tokens and the one or more item related tokens;
assigning, by the processing unit [104], a score to the one or more active order items based on the comparison of the one or more response related tokens and the one or more item related tokens;
generating, by the processing unit [104], one of a second positive indication and a second negative indication based on the score assigned to the one or more active order items; and
identifying, by the identification unit [102], the target order item from the one or more active order items based on the second positive indication.

10. The method as claimed in claim 9, wherein the second positive indication is generated based on at least one of a successful identification of:
an order item associated with a target score, from the one or more active order items, and
an order item associated with a score less than the target score, in an event the one or more active order items includes a single item.

11. The method as claimed in claim 9, wherein the second negative indication is generated based on at least one of an unsuccessful identification of:
the order item associated with the target score, from the one or more active order items, and
the order item associated with the score less than the target score, in an event the one or more active order items includes the single item.

12. The method as claimed in claim 9, the method comprising:
determining, by the processing unit [104], one or more phonetic representation of the one or more item related tokens;
comparing, by the processing unit [104], the one or more response related tokens with the one or more phonetic representation of the one or more item related tokens;
determining, by the processing unit [104], a similarity score associated with the one or more active order items based on the comparison of the one or more response related tokens with the one or more phonetic representation of the one or more item related tokens; and
identifying, by the identification unit [102], the target order item from the one or more active order items based on the similarity score associated with the one or more active order items.

13. The method as claimed in claim 9, the method comprising:
identifying by the identification unit [102], one or more tokens related to a partial product utterance in the at least one processed response based on the second negative indication;
comparing, by the processing unit [104], the one or more tokens related to partial product utterance and the one or more item related tokens;
determining, by the processing unit [104], a partial similarity score associated with the one or more active order items based on the comparison of the one or more tokens related to the partial product utterance and the one or more item related tokens; and
identifying, by the identification unit [102], the target order item from the one or more active order items based on the partial similarity score associated with the one or more active order items.

14. The method as claimed in claim 13, wherein the identification of the target order item from the one or more active order items is further based on at least one of:
an identification of an order item associated with a target partial similarity score, from the one or more active order items, and
an identification of an order item associated with a score less than the target partial similarity score, in an event the one or more active order items includes the single item.

15. The method as claimed in claim 13, the method comprising identifying, by the identification unit [102], the target order item from the one or more active order items based on one or more vertical names associated with the one or more active order items and the partial similarity score associated with the one or more active order items.

16. A system for identifying a target order item, the system comprising:
an identification unit [102], configured to:
identify, one or more active order items associated with one or more users, and
identify, one or more features of the one or more active order items; and
a processing unit [104], configured to:
determine, a ranking score of the one or more active order items based on the one or more features of the one or more active order items,
compare, the ranking score of the one or more active order items with a threshold ranking score, wherein:
the identification unit [102], is further configured to identify, the target order item based at least on a successful comparison of a ranking score of a first active order item from the one or more active order items with the threshold ranking score.

17. The system as claimed in claim 16, wherein the one or more active order items are identified based on one or more query indication from the one or more user.

18. The system as claimed in claim 16, wherein the processing unit [104] is further configured to determine the ranking score of the one or more active order items based on a pre-trained dataset.

19. The system as claimed in claim 16, wherein to identify, the target order item:
a transceiver unit [106], is configured to receive a user input from the one or more users based on the successful comparison of the ranking score of the first active order item with the threshold ranking score,
the processing unit [104], is configured to generate one of a first positive indication and a first negative indication based on the user input, and
the identification unit [102], is configured to identify the first active order item as the target order item based on the first positive indication.

20. The system as claimed in claim 16, wherein the first positive indication is generated by the processing unit [104] based on a receipt of the user input indicating a successful confirmation of the first order item as the target order item.

21. The system as claimed in claim 16, wherein the first negative indication is generated by the processing unit [104] based on a receipt of the user input indicating an unsuccessful confirmation of the first order item as the target order item.

22. The system as claimed in claim 16, wherein:
the processing unit [104], is further configured to generate a query based on the first negative indication, and
the transceiver unit [106], is further configured to:
provide, the query to the one or more users, and
receive, at least one response to the query from the one or more users.

23. The system as claimed in claim 22, wherein the processing unit [104] is further configured to process the at least one response, wherein processing of the at least one response further comprises at least one of:
removal of, at least one generic token from the at least one response; and
joining, two or more continuous single letter words identified based on the at least one response.

24. The system as claimed in claim 23, wherein:
the identification unit [102], is further configured to:
identify, one or more response related tokens in the at least one processed response,
identify, one or more item related tokens in a title of the one or more active order items, and
the processing unit [104], is further configured to:
compare the one or more response related tokens and the one or more item related tokens,
assign, a score to the one or more active order items based on the comparison of the one or more response related tokens and the one or more item related tokens, and
generate, one of a second positive indication and a second negative indication based on the score assigned to the one or more active order items, wherein:
the identification unit [102], is further configured to identify the target order item from the one or more active order items based on the second positive indication.

25. The system as claimed in claim 24, wherein the second positive indication is generated based on at least one of a successful identification of:
an order item associated with a target score, from the one or more active order items, and
an order item associated with a score less than the target score, in an event the one or more active order items includes a single item.

26. The system as claimed in claim 24, wherein the second negative indication is generated based on at least one of an unsuccessful identification of:
the order item associated with the target score, from the one or more active order items, and
the order item associated with the score less than the target score, in an event the one or more active order items includes the single item.

27. The system as claimed in claim 24, wherein:
the processing unit [104], is further configured to:
determine, one or more phonetic representation of the one or more item related tokens,
compare, the one or more response related tokens with the one or more phonetic representation of the one or more item related tokens, and
determine, a similarity score associated with the one or more active order items based on the comparison of the one or more response related tokens with the one or more phonetic representation of the one or more item related tokens, and
the identification unit [102], is further configured to identify the target order item from the one or more active order items based on the similarity score associated with the one or more active order items.

28. The system as claimed in claim 24, wherein:
the identification unit [102], is further configured to identify, one or more tokens related to a partial product utterance in the at least one processed response based on the second negative indication, and
the processing unit [104], is further configured to:
compare, the one or more tokens related to partial product utterance and the one or more item related tokens,
determine, a partial similarity score associated with the one or more active order items based on the comparison of the one or more tokens related to the partial product utterance and the one or more item related tokens, wherein:
the identification unit [102], is further configured to identify the target order item from the one or more active order items based on the partial similarity score associated with the one or more active order items.

29. The system as claimed in claim 28, wherein the identification of the target order item from the one or more active order items is further based on at least one of:
an identification of an order item associated with a target partial similarity score, from the one or more active order items, and
an identification of an order item associated with a score less than the target partial similarity score, in an event the one or more active order items includes the single item.

30. The system as claimed in claim 28, wherein the identification unit [102] is further configured to identify, the target order item from the one or more active order items based on one or more vertical names associated with the one or more active order items and the partial similarity score associated with the one or more active order items.
